(19) United States
(12) Patent Application Publication
(10) Pub. No.: US 2024/0142847 A1
(43) Pub. Date: May 2, 2024

(54) DISPLAY DEVICE

(71) Applicant: E Ink Holdings Inc., HSINCHU (TW)

(72) Inventors: Liang-Yu LIN, HSINCHU (TW); Po-Yuan LO, HSINCHU (TW); Ian FRENCH, HSINCHU (TW)

(21) Appl. No.: 18/335,125

(22) Filed: Jun. 14, 2023

(30) Foreign Application Priority Data
Nov. 2, 2022 (TW) 111141742

(51) Int. Cl. G02F 1/1677; G02F 1/167; G02F 1/1676

(52) U.S. Cl. CPC G02F 1/1677; G02F 1/167; G02F 1/1676

(57) ABSTRACT

A display device includes a panel, a conductive layer, a first color filter array and a second color filter array. The panel has a display surface and multiple sub-pixel regions where the multiple sub-pixel regions and the conductive layer are on this display surface. The first color filter array including multiple first color filter elements is disposed on the conductive layer while the second color filter array including multiple second color filter elements is disposed on the first color filter array. One first overlaid region and one second overlaid region are defined by the orthogonal projections of the color filter elements within one of the sub-pixel regions. In one sub-pixel region, a section of the first overlaid region does not overlap a section of the second overlaid region.

### RELATED APPLICATIONS

This application claims priority to Taiwan Application Serial Number 111141742, filed Nov. 2, 2022, which is herein incorporated by reference in its entirety.

### BACKGROUND

### Technical Field

The present disclosure relates to a display device. More particular, the present disclosure relates to the display device with high covering rate of pixels.

### Description of Related Art

In present, an electrophoretic display (EPD) filters the light reflected by a display medium layer with a color filter array made by printing and to form the corresponding images. The color filter array is generally formed on a piece of glass and includes color filter elements with various colors, such as red, green and blue filter elements. However, when the covering rate of the color filter elements is high, that is, when the pixel fill factor (PFF) is high, one single color filter element may occupy larger area. Thus, the adjacent color filter elements are prone to mixing with each other and leading to mixing issue due to the limitation of printer or inkjetting. In contrast, when the covering rate of the color filter elements is low, the color present of electrophoretic display may be influenced so that the quality of the images is reduced.

### SUMMARY

Accordingly, the disclosure is to provide a display device, and this display device is able to increase the covering rate of pixels of the color filter array without mixing the adjacent color filter elements, thereby improving the quality of the images.

At least one embodiment of the disclosure provides a display device. The display device includes a display panel, which has a display surface and a plurality of sub-pixel regions located on the display surface. The display device includes a conductive layer located on the display surface, a first color filter array located on the conductive layer including a plurality of first color filter elements and a second color filter array located on the first color filter array including a plurality of second color filter elements. Each of the first color filter elements is aligned to one of the sub-pixel regions, and thus an orthogonal projection of each of the first color filter elements onto one of the sub-pixel regions defines a first overlaid region. Each of the second color filter elements is aligned to one of the sub-pixel regions, and thus an orthogonal projection of each of the second color filter elements onto one of the sub-pixel regions defines a second overlaid region. The first overlaid region and the second overlaid region are in the same sub-pixel region where a section of the first overlaid region does not overlap a section of the second overlaid region.

At least in one embodiment of the disclosure, the shape of the first overlaid region and the shape of the second overlaid region within the same sub-pixel region are complementary.

At least in one embodiment of the disclosure, the other section of the first overlaid region overlaps the other section of the second overlaid region within the same sub-pixel region.

At least in one embodiment of the disclosure, the area of the first overlaid region and the area of the second overlaid region within the same sub-pixel region are unequal.

At least in one embodiment of the disclosure, at least two of the first overlaid regions have unequal areas.

At least in one embodiment of the disclosure, at least two of the second overlaid regions have unequal areas.

At least in one embodiment of the disclosure, the first overlaid region surrounds the second overlaid region within the same sub-pixel region.

At least in one embodiment of the disclosure, the second overlaid region surrounds the first overlaid region within the same sub-pixel region.

At least in one embodiment of the disclosure, the shape of one of the first overlaid regions is the same as the shape of one of the second overlaid regions.

At least in one embodiment of the disclosure, the plurality of first color filter elements are separated from each other and the plurality of second color filter element are separated from each other.

At least in one embodiment of the disclosure, some of the first color filter elements are arranged along a direction. And each adjacent two of the some of the first color filter elements are of different colors.

At least in one embodiment of the disclosure, the first color filter element and the second color filter element aligned to one of the sub-pixel regions are of the same color.

At least in one embodiment of the disclosure, the first color filter element and the second color filter element aligned to one of the sub-pixel regions are of different colors.

At least one embodiment of the disclosure provides a display device. The display device includes a display panel, which has a display surface and a plurality of sub-pixel regions located on the display surface. The display device includes a conductive layer located on the display surface, a first color filter array located on the conductive layer including a plurality of first color filter elements and a second color filter array located on the first color filter array including a plurality of second color filter elements. Each of the first color filter elements is aligned to one of the sub-pixel regions, and thus an orthogonal projection of each of the first color filter elements onto one of the sub-pixel regions defines a first overlaid region. Each of the second color filter elements is aligned to one of the sub-pixel regions, and thus an orthogonal projection of each of the second color filter elements onto one of the sub-pixel regions defines a second overlaid region. The first overlaid region and the second overlaid region are in the same sub-pixel region where a section of the first overlaid region does not overlap a section of the second overlaid region. The area of the first overlaid region and the area of the second overlaid region within the same sub-pixel region are equal.

According to the aforementioned embodiments, the color filter elements of the first color filter array and of the second color filter array are aligned to the same sub-pixel, and their overlaid regions overlap. Therefore, the covering rate of the color filter elements is enlarged without mixing the color filter elements, thereby achieving a good color performance.

### BRIEF DESCRIPTION OF THE DRAWINGS

To illustrate more clearly the aforementioned and the other features, merits, and embodiments of the present disclosure, the description of the accompanying figures are as follows:

FIG. 1 illustrates a top view of a display device in accordance with at least one embodiment of the present disclosure;

FIG. 2 illustrates a cross-sectional view taken along a line A-A of FIG. 1;

FIG. 3 illustrates a local top view of a display device of FIG. 2;

FIG. 4 illustrates a local cross-sectional view of a display device in accordance with another embodiment of the present disclosure;

FIG. 5 illustrates a local cross-sectional view of a display device in accordance with another embodiment of the present disclosure;

FIG. 6 illustrates a local top view of the first color filter array of FIG. 2;

FIG. 7 illustrates a local cross-sectional view of a display device in accordance with another embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the following description, the dimensions (such as lengths, widths and thicknesses) of components (such as layers, films, substrates and regions) in the drawings are enlarged not-to-scale, and the number of components may be reduced in order to clarify the technical features of the disclosure. Therefore, the following illustrations and explanations are not limited to the number of components, the number of components, the dimensions and the shapes of components, and the deviation of size and shape caused by the practical procedures or tolerances are included. For example, a flat surface shown in drawings may have rough and/or non-linear features, while angles shown in drawings may be circular. As a result, the drawings of components shown in the disclosure are mainly for illustration and not intended to accurately depict the real shapes of the components, nor are intended to limit the scope of the claimed content of the disclosure.

Further, when a number or a range of numbers is described with “about,” “approximate,” “substantially,” and the like, the term is intended to encompass numbers that are within a reasonable range considering variations that inherently arise during manufacturing as understood by one of ordinary skill in the art. In addition, the number or range of numbers encompasses a reasonable range including the number described, such as within +/−30%, +/−20%, +/−10% or +/−5% of the number described, based on known manufacturing tolerances associated with manufacturing a feature having a characteristic associated with the number. The words of deviations such as “about,” “approximate,” “substantially,” and the like are chosen in accordance with the optical properties, etching properties, mechanical properties or other properties. The words of deviations used in the optical properties, etching properties, mechanical properties or other properties are not chosen with a single standard.

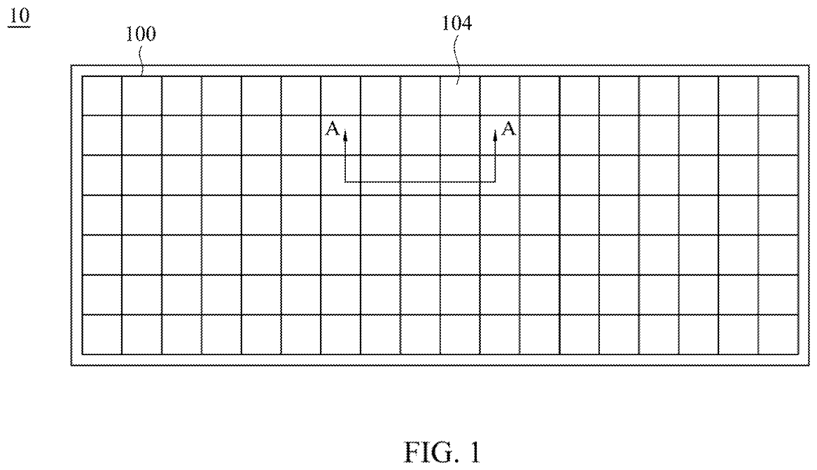

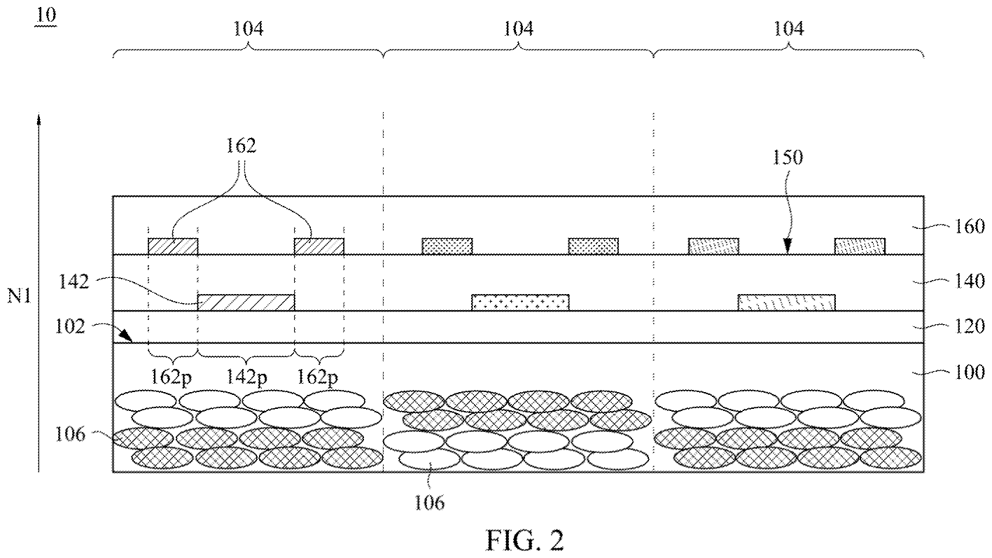

FIG. 1 illustrates a top view of a display device 10 in accordance with one embodiment of the present disclosure while FIG. 2 illustrates a cross-sectional view taken along a line A-A of FIG. 1. Referring to FIG. 1 and FIG. 2, the display device 10 includes a display panel 100, a conductive layer 120, a first color filter array 140 and a second color filter array 160. The display panel 100 has a display surface 102 and a plurality of sub-pixel regions 104 located on the display surface 102. The conductive layer 120 is located on the display surface 102 while the first color filter array 140 is located on the conductive layer 120, and the second color filter array 160 is located on the first color filter array 140.

In this embodiment, the conductive layer 120 is located between the display panel 100 and the first color filter array 140, and may include one kind of transparent conductive material, for example, indium tin oxide (ITO), indium zinc oxide (IZO), antimony-doped tin oxide (ATO), aluminum-doped tin oxide, aluminum-doped zinc oxide (AZO), indium gallium zinc oxide (IGZO) or other suitable component, or combinations thereof. The conductive layer 120 may include an adhesive bonding material, such as a conductive polymer material, for the conductive layer 120 to be adhered on the display panel 100. In addition, the bonding interface between the first color filter array 140 and the second color filter array 160 is a flat surface 150 which allows the second color filter array 160 to be substantially parallel to the first color filter array 140.

In various embodiments of the present disclosure, the relative positions of the first color filter elements 142, the second color filter elements 162 and the sub-pixel regions 104 are defined by the concept of the orthogonal projection. The mentioned “orthogonal projection” is not identical with the “normal projection” in cartography. Instead, the orthogonal projection in this disclosure is to define a surface and to align an object to this surface (i.e. to project the object onto this surface along the normal line of the surface), and then to define a region on the surface which overlaps the object, in which the region is equivalent to the projection of the object onto the surface. Hence, the relative positions of different objects on the surface may be acquired. For instance, when the vertical distances between two objects and a level are unequal, the relative positions on the level of these two objects can be clearly shown.

As shown in FIG. 2, the first color filter array 140 includes the plurality of first color filter elements 142, and each of the first color filter elements 142 may be aligned to one of the sub-pixel regions 104 on the display panel 100, and thereby an orthogonal projection of each of the first color filter elements 142 onto one of the sub-pixel regions 104 defines a first overlaid region 142p within the sub-pixel region 104. In addition, the second color filter array 160 is located on the first color filter array 140, and includes the plurality of second color filter elements 162. Each of the second color filter elements 162 may be aligned to one of the sub-pixel region 104 on the display panel 100, and thereby an orthogonal projection of each of the second color filter elements 162 onto one of the sub-pixel regions 104 defines a second overlaid region 162p within the sub-pixel region 104.

It should be noted, one of the first color filter elements 142 and one of the second color filter elements 162 are align to the same sub-pixel region 104. In other words, each of the sub-pixel regions 104 may include one first overlaid region 142p and one second overlaid region 162p. That is, one of the first overlaid regions 142p and one of the second overlaid regions 162p are within the same sub-pixel region 104.

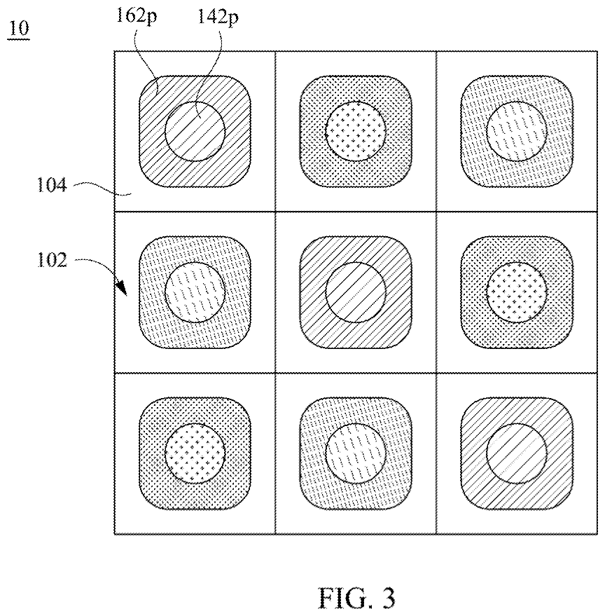

FIG. 3 illustrates a local top view of the display device 10 of FIG. 2, and further depicts the first overlaid regions 142p and the second overlaid regions 162p defined by the first color filter elements 142 and the second color filter elements 162, respectively. In various embodiments of the present disclosure, a section of the first overlaid region 142p does not overlap a section of the second overlaid region 162p. Moreover, the other section of the first overlaid region 142p may or may not overlap the other section of the second overlaid regions 162p. In other words, not only the section of the first overlaid region 142p does not overlap the section of the second overlaid region 162p, but the whole first overlaid region 142p may not overlap the whole second overlaid region 162p.

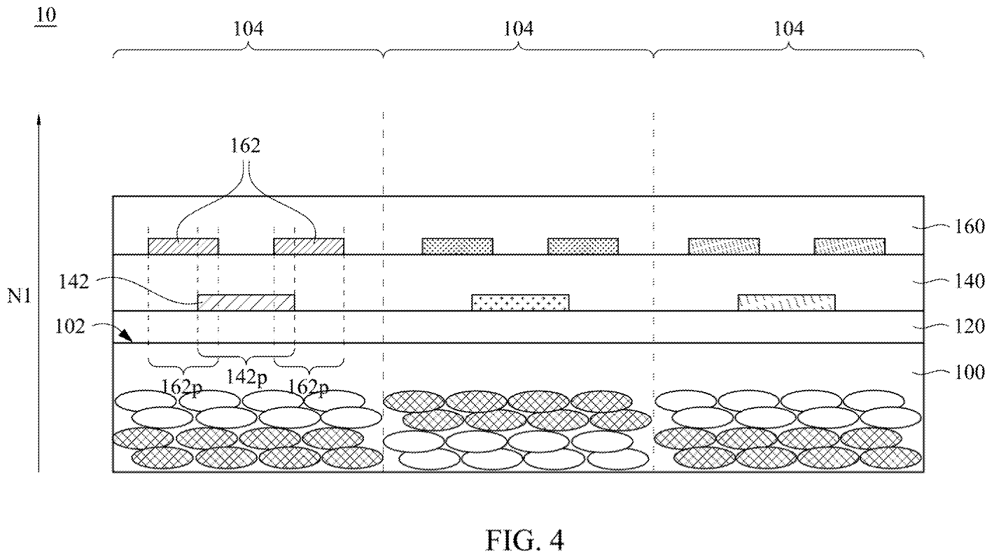

For example, referring to FIG. 2 and FIG. 3, the whole first overlaid region 142p may not overlap the whole second overlaid region 162p, that is, the second color filter element 162 does not overlap the first color filter element 142 in the normal direction N1, as shown in FIG. 2. However, according to another embodiment illustrated in FIG. 4, the other section of the first overlaid region 142p may overlap the other section of the second overlaid region 162p, that is, the second color filter element 162 partially overlaps the first color filter element 142 in the normal direction N1.

Referring to FIG. 2 and FIG. 3, the shape of the first overlaid region 142p and the shape of the second overlaid region 162p within the same sub-pixel region 104 are complementary. Furthermore, the union of shapes and the union of areas of one first overlaid region 142p and one second overlaid region 162p are approximate to the shape and the area of one sub-pixel region 104. In other words, one first overlaid region 142p and one second overlaid region 162p may jointly cover one sub-pixel region 104. In addition, the area of the first overlaid region 142p and the area of the second overlaid region 162p within the same sub-pixel region 104 are unequal to each other. However, the present disclosure is not limited by this embodiment, and the area of the first overlaid region 142p and the area of the second overlaid region 162p within the same sub-pixel region 104 may be equal.

As shown in the embodiment of FIG. 3, the second overlaid region 162p surrounds the first overlaid region 142p within the same sub-pixel region 104. However, the present disclosure is not limited by this embodiment. In other embodiments, the first overlaid region 142p may surround the second overlaid region 162p within the same sub-pixel region 104. Moreover, at least one of the first overlaid region 142p and the second overlaid region 162p may include a plurality of separate patterns. For example, the first overlaid region 142p may include the plurality of separate dots, such as four dots, and these four dots may be located around one of the second overlaid regions 162p, thereby surrounding the second overlaid region 162p.

It is worth mentioning that the shapes, areas and distributions of the first overlaid regions 142p and the second overlaid regions 162p depend on the shapes, areas and distributions of the first color filter elements 142 and the second color filter elements 162 since the overlaid regions (the first overlaid region 142p and the second overlaid region 162p) are defined by the orthogonal projections of the color filter elements (the first color filter elements 142 and the second color filter elements 162). Therefore, the descriptions of the shapes areas and distributions in the aforementioned embodiments are primary according to the first overlaid regions 142p and the second overlaid regions 162p rather than the first color filter elements 142 and the second color filter elements 162.

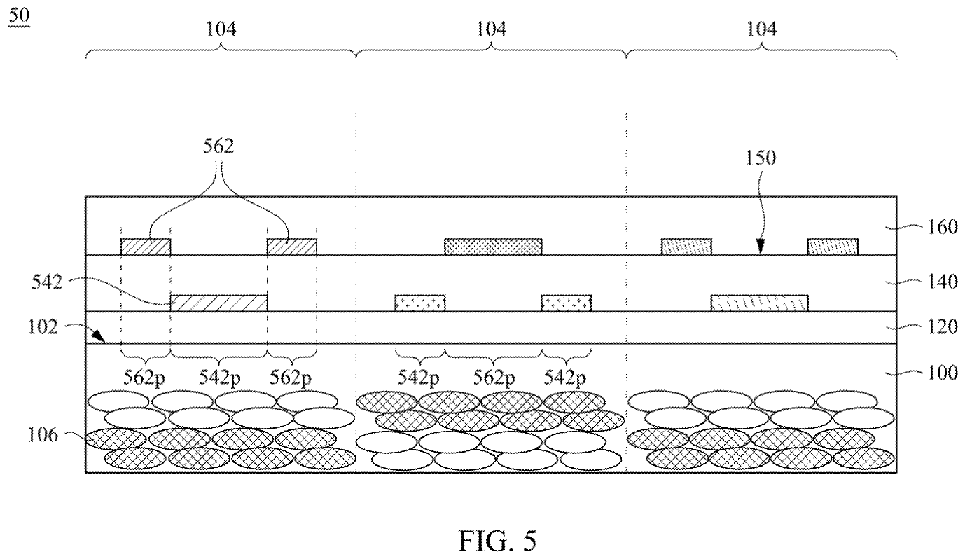

FIG. 5 illustrates a cross-sectional view of a display device in accordance with another embodiment of the present disclosure. In this embodiment, a display device 50 is approximately similar to the display device 10 of FIG. 2. However, the distribution of the first color filter elements 542 and the second color filter elements 562 in the display device 50 is different from the distribution of the first color filter elements 142 and the second color filter elements 162 in the display device 10. As shown in FIG. 5, the first color filter elements 542 may define the first overlaid regions 542p by the orthogonal projections, and the areas of at least two of the first overlaid regions 542p are unequal to each other. The second color filter elements 562 may define the second overlaid regions 562p by the orthogonal projections, and the areas of at least two of the second overlaid regions 562p are unequal to each other. For example, the area of the first overlaid region 542p on the far left is equal to the area of the first overlaid region 542p on the far right in FIG. 5, while the area of the first overlaid region 542p on the far left is unequal to the area of the first overlaid region 542p in the middle.

Furthermore, the shape of one of the first overlaid regions 542p is the same as the shape of one of the second overlaid regions 562p in this embodiment. As shown in FIG. 5, the shape of the first overlaid region 542p on the far left is the same as the shape of the second overlaid region 562p in the middle. However, the present disclosure is not limited by this embodiment. For example, the shape of at least one first overlaid region 542p may be the same as each shape of at least two second overlaid regions 562p. In addition, each shape of at least two first overlaid regions 542p may be the same as the shape of at least one second overlaid region 562p. Moreover, the shape of at least one first overlaid region 542p may be the same as the shape of at least one second overlaid region 562p.

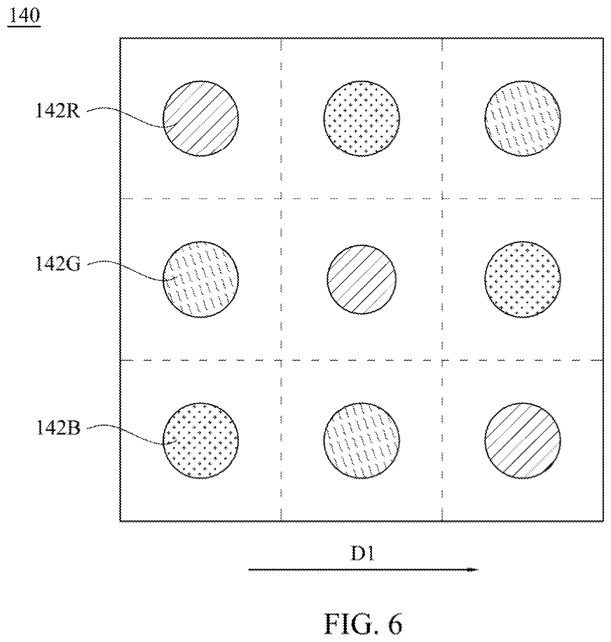

FIG. 6 illustrates a top view of the first color filter array 140 of FIG. 2, where the second color filter array 160 is omitted. As shown in FIG. 6, the first color filter elements 142 are separated from each other. In the first color filter array 140, some of the first color filter elements 142 are arranged along the direction D1 while each adjacent two of these first color filter elements 142 along the direction D1 are of different colors. For example, these first color filter elements 142 may include the plurality of red filter elements 142R, the plurality of blue filter elements 142B and the plurality of green filter elements 142G.

In the embodiment, the first color filter element 142 and the second color filter element 162 aligned to the same sub-pixel region 104 are of the same color. In other words, the second color filter elements 162 may be in red, blue or green. However, the present disclosure is not limited by this embodiment. The first color filter elements 142 and the second color filter elements 162 may be none of these three colors (red, blue or green), but cyan, magenta or yellow.

It is worth mentioning, in other embodiments, the first color filter element 142 and the second color filter element 162 aligned to the same sub-pixel region 104 may be of different colors. For instance, when the first color filter element 142 is the red filter element 142R, the second color filter element 162 of the same sub-pixel region 104 may be of other color, such as yellow or green. As a result, not only the hue of the display images can be adjusted but the saturation of the display color may be increased.

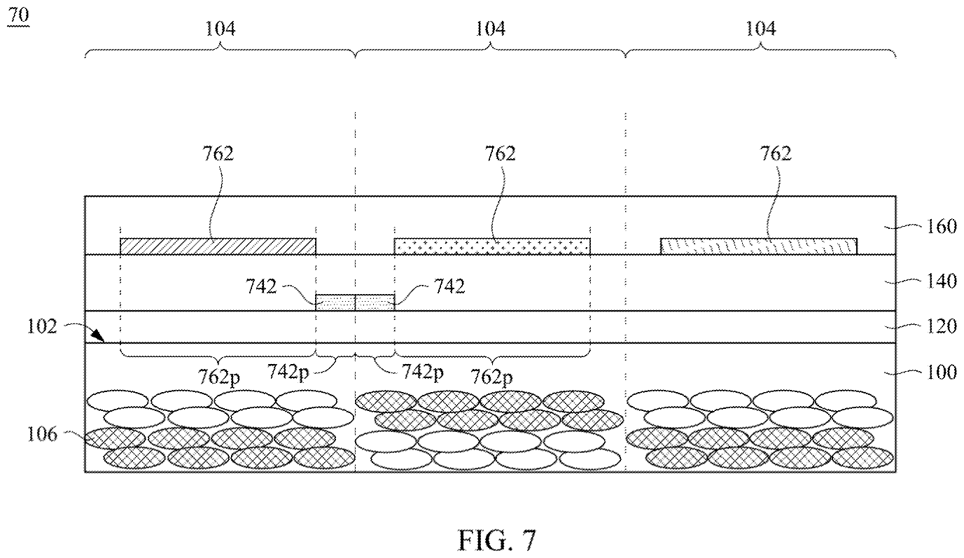

FIG. 7 illustrates a cross-sectional view of a display device in accordance with another embodiment of the present disclosure. In a display device 70, the first color filter elements 742 and any of the second color filter elements 762 are of different colors. In particular, the first color filter elements 742 may be yellow while the second color filter elements 762 are red, blue and green as shown in FIG. 7. Each of the first overlaid regions 742p defined by the orthogonal projection of the first color filter elements 742 is located between the second overlaid regions 762p of two adjacent sub-pixel regions 104. Moreover, two first overlaid regions 742p of two adjacent sub-pixel regions 104 may be connected to each other, and thus, these two first overlaid regions 742p may substantially be regarded as the overlaid region of one color filter element across two different sub-pixel regions 104.

Furthermore, the first color filter elements 742 in other embodiments are not limited to yellow, for example, the first color filter elements 742 may be cyan or magenta. The first color filter elements 742 may also be red, green or blue while the second color filter elements 762 may be cyan, yellow and magenta. In other words, the colors of the first color filter elements 742 and the colors of the second color filter elements 762 are interchangeable in different embodiments. It should be noted, the area of the first overlaid regions 742p defined by first color filter elements 742 does not exceed 30% of the area of the sub-pixel regions 104. In addition, the first overlaid regions 742p may be partially overlap the second overlaid regions 762p even though the embodiment is not shown in FIG. 7.

Referring to FIG. 2, the display device 10 may be a color electrophoretic display with a plurality of capsules 106, where the conductive layer 120 is disposed on the display medium layer (not shown) including the capsules 106. The first color filter array 140 and the second color filter array 160 may be formed on the conductive layer 120 by ink printing or inkjetting. Generally, the adjacent color filter elements are prone to mixing with each other when the covering rate of pixels (or the pixel fill factor, the PFF) of the color filter array exceeds about 40%. In the embodiment, the covering rates of pixels (or the PFF) of the first color filter array 140 and the second color filter array 160 may be lower than 40%, for example, range from 25% to 35%, in order to completely prevent the color filter elements from mixing.

For example, the first color filter array 140 includes the plurality of first color filter elements 142, and each of the first color filter elements 142 is aligned to one of the sub-pixel regions 104. The ratio of the areas of the first color filter element 142 to the sub-pixel region 104 is from 25% to 35%. The second color filter array 160 includes the plurality of second color filter elements 162, and each of the second color filter elements 162 is aligned to one of the sub-pixel region 104. The ratio of the areas of the second color filter element 162 to the sub-pixel region 104 is from 25% to 35%.

Furthermore, in this embodiment, all the first color filter elements 142 do not overlap any of the second color filter elements 162. Hence, the overall area of the first color filter element 142 and the second color filter element 162 aligned to the same sub-pixel region 104 is equivalent to the covering rate of pixels (or the PFF) of this sub-pixel region 104. As mentioned above, the respective covering rates of pixels (or the PFF) of the first color filter elements 142 and the second color filter elements 162 are from 25% to 35%, so that the sum of these covering rates of pixels may be from 50% to 70%. It should be noted that the number of color filter arrays included in one display device of the present disclosure is not limited to 2, but the number of color filter arrays may be more than 2.

In conclusion, since the adjacent color filter elements in one color filter array should not be too close to mix with each other, the covering rate of pixels of each color filter array is limited. By disposing two or more than two color filter arrays on the display panel, those color filter elements of the color filter arrays on different level are able to complement to each other, so that the overall covering rate of pixels can be increased, and thereby improving the color performance.

Although the embodiments of the present disclosure have been disclosed as above in the embodiments, they are not intended to limit the embodiments of the present disclosure. Any person having ordinary skill in the art can make various changes and modifications without departing from the spirit and the scope of the embodiments of the present disclosure. Therefore, the protection scope of the embodiments of the present disclosure should be determined according to the scope of the appended claims.

What is claimed is:

1. A display device, comprising:
a display panel having a display surface and a plurality of sub-pixel regions located on the display surface;
a conductive layer located on the display surface;
a first color filter array located on the conductive layer, comprising a plurality of first color filter elements, wherein each of the first color filter elements is aligned to one of the sub-pixel regions, and thus an orthogonal projection of each of the first color filter elements onto one of the sub-pixel regions defines a first overlaid region; and
a second color filter array located on the first color filter array, including a plurality of second color filter elements, wherein each of the second color filter elements is aligned to one of the sub-pixel regions, and thus an orthogonal projection of each of the second color filter elements onto one of the sub-pixel regions defines a second overlaid region, wherein the first overlaid region and the second overlaid region are within the same sub-pixel region;
wherein a section of the first overlaid region does not overlap a section of the second overlaid region within the same sub-pixel region.

2. The display device of claim 1, wherein the shape of the first overlaid region and the shape of the second overlaid region within the same sub-pixel region are complementary.

3. The display device of claim 1, wherein the other section of the first overlaid region overlaps the other section of the second overlaid region within the same sub-pixel region.

4. The display device of claim 1, wherein the area of the first overlaid region and the area of the second overlaid region within the same sub-pixel region are unequal.

5. The display device of claim 1, wherein at least two of the first overlaid regions have unequal areas.

6. The display device of claim 1, wherein at least two of the second overlaid regions have unequal areas.

7. The display device of claim 1, wherein the first overlaid region surrounds the second overlaid region within the same sub-pixel region.

8. The display device of claim 1, wherein the second overlaid region surrounds the first overlaid region within the same sub-pixel region.

9. The display device of claim 1, wherein the shape of one of the first overlaid regions is the same as the shape of one of the second overlaid regions.

10. The display device of claim 1, wherein the plurality of first color filter elements are separated from each other, and the plurality of second color filter element are separated from each other.

11. The display device of claim 1, wherein some of the first color filter elements are arranged along a direction, and each adjacent two of the some of the first color filter elements are of different colors.

12. The display device of claim 1, wherein the first color filter element and the second color filter element aligned to one of the sub-pixel regions are of the same color.

13. The display device of claim 1, wherein the first color filter element and the second color filter element aligned to one of the sub-pixel regions are of different colors.

14. A display device, comprising:
a display panel having a display surface and a plurality of sub-pixel regions located on the display surface;
a conductive layer located on the display surface;
a first color filter array located on the conductive layer, comprising a plurality of first color filter elements, wherein each of the first color filter elements is aligned to one of the sub-pixel regions, and thus an orthogonal projection of each of the first color filter elements onto one of the sub-pixel regions defines a first overlaid region; and
a second color filter array located on the first color filter array, including a plurality of second color filter elements, wherein each of the second color filter elements is aligned to one of the sub-pixel regions, and thus an orthogonal projection of each of the second color filter elements onto one of the sub-pixel regions defines a second overlaid region, wherein the first overlaid region and the second overlaid region are within the same sub-pixel region;
wherein a section of the first overlaid region does not overlap a section of the second overlaid region within the same sub-pixel region;
wherein the area of the first overlaid region and the area of the second overlaid region within the same sub-pixel region are equal.

15. The display device of claim 14, wherein the shape of the first overlaid region and the shape of the second overlaid region within the same sub-pixel region are complementary.
